(19) United States
(12) Patent Application Publication
(10) Pub. No.: US 2023/0216300 A1
(43) Pub. Date: Jul. 6, 2023

(54) FIXED DC BUS POWER ELECTRONIC SYSTEMS AND METHODS

(71) Applicant: Nextracker LLC, Fremont, CA (US)

(72) Inventors: Yang Liu, Mountain View, CA (US); Alexander W. AU, Oakland, CA (US); Sandeep Sanjiva Lele, Sunnyvale, CA (US)

(73) Assignee: Nextracker LLC, Fremont, CA (US)

(21) Appl. No.: 18/074,054

(22) Filed: Dec. 2, 2022

Related U.S. Application Data
(60) Provisional application No. 63/285,486, filed on Dec. 3, 2021.

(51) Int. Cl. H02J 3/14; H02J 13/00

(52) U.S. Cl. CPC H02J 3/14; H02J 13/00034

(57) ABSTRACT

A common enclosure includes a housing, inverter input connectors and an inverter output connector coupled to the housing, a common DC bus mechanically coupled to the housing and electrically coupled to the inverter input connectors, a common AC bus mechanically coupled to the housing and electrically coupled between the inverter output connector and a power grid connector, a controller mechanically coupled to the housing and electrically coupled to the common DC and AC buses, local controllers coupled to the inverters, decentralized controllers coupled to the local controllers, and a centralized controller in communication with the local controllers. The decentralized controllers generate decentralized control signals for the local controllers based on measured voltages and currents of the electrical power grid and the inverters. The centralized controller transmits centralized control signals to the local controllers to maintain a constant voltage on the common DC bus based on a predicted DC load.

### CROSS-REFERENCE TO RELATED APPLICATION

The present application claims the benefit of, and priority to, U.S. Provisional Patent Application Ser. No. 63/285,486, filed on Dec. 3, 2021, the entire content of which is hereby incorporated by reference herein.

### FIELD

The technology of the disclosure is generally related to power electronic systems, which include common enclosures, and methods for maintaining a constant DC voltage at the input to inverters.

### BACKGROUND

In power systems for some solar applications, multiple parallel bidirectional inverters are coupled to multiple arrays of photovoltaic devices and the bidirectional inverters are coupled to a DC bus. The power systems may include large numbers of bidirectional inverters (e.g., greater than 40 bidirectional inverters) coupled together. The power systems may also include many other electronic components. Thus, the power systems can be very complex, making it challenging to deploy and maintain the power systems.

### SUMMARY

In one aspect, the disclosure features a common enclosure including a housing, inverter input connectors and an inverter output connector coupled to the housing, a common DC bus mechanically coupled to the housing and electrically coupled to the inverter input connectors, a common AC bus mechanically coupled to the housing and electrically coupled between the inverter output connector and a power grid connector, a controller mechanically coupled to the housing and electrically coupled to the common DC bus and the common AC bus, local controllers coupled to the inverters, decentralized controllers coupled to the local controllers, and a centralized controller in communication with the local controllers.

The decentralized controllers measure voltages and currents of the electrical power grid and the inverters, and generate decentralized control signals for the local control controllers based on the measured voltages and currents of the electrical power grid and the inverters. The centralized controller predicts a DC load and transmits centralized control signals to the local controllers to maintain a constant voltage on the common DC bus based on the predicted DC load.

In aspects, the disclosure may implement one or more of the following features. The common enclosure may include a cooling device mechanically coupled to the housing and electrically coupled to the controller. The common enclosure may include a communication device mechanically coupled to the housing and electrically coupled to the controller. The communication device may include a Bluetooth communication device. The housing may be weather resistant.

The common enclosure may include mounting hardware coupled to the housing. The common enclosure may include an overcurrent and overvoltage protection circuit electrically coupled to the common DC bus and the common AC bus.

The common enclosure may include a panel door rotatably coupled to the housing, a sensor coupled to the panel door and configured to sense the opening of the panel door, and a switch coupled to the common DC bus. The controller may be electrically coupled to the sensor and the switch, and may open the switch to disrupt power flow through the common DC bus.

The centralized controller may execute a polynomial droop control algorithm. Each decentralized controller may execute a polynomial droop control algorithm. Each decentralized controller may execute a droop control algorithm.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a perspective view of common enclosures for housing a fixed DC bus power electronic system of the disclosure.

FIG. 2 is a block diagram of a coordinating centralized control architecture.

FIG. 3 is a block diagram of a coordinating decentralized control architecture.

FIGS. 4A and 4B are graphs of droop curves.

FIGS. 5-7 are circuit diagrams of a system that incorporates centralized and decentralized control features.

FIG. 8 is a circuit diagram of a parallel inverter system according to aspects of the disclosure.

### DETAILED DESCRIPTION

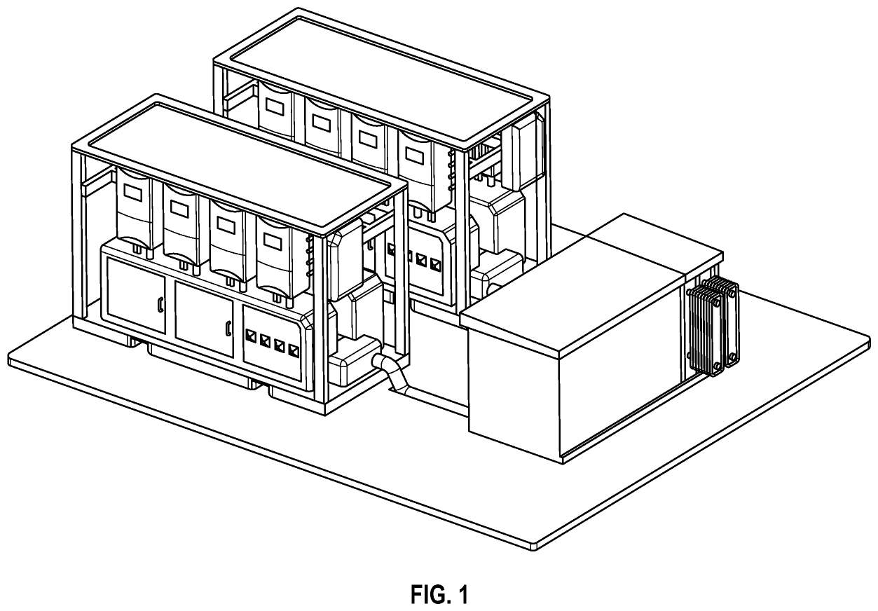

FIG. 1 illustrates common enclosures that house a DC bus power electronic system of the disclosure. The power electronic system includes two or more inverters. Each inverter may be individually packaged in its own enclosure placed in parallel with other inverters to operate in a common AC bus and a common DC bus. Furthermore, the DC bus is coupled to photovoltaic (PV) devices, batteries, and any other sources or loads. In normal operating conditions, the voltage of the DC bus is maintained at a fixed level using the control architecture of the disclosure.

In aspects, the common enclosure houses the inverters, the AC bus, and the DC bus. The power electronic subsystems may be modularized and mounted in the common enclosure. The common enclosure is outdoor rated so that the common enclosure may be installed adjacent to an energy generation source, e.g., a renewable energy source, such as photovoltaic devices. The common enclosure may incorporate a common DC bus, a common AC bus, overcurrent and overvoltage protection, communications, and cooling.

The common enclosure may also incorporate connectors that mate with the power electronics. The common enclosure may integrate mounting hardware, thereby enabling quick and easy installation in the field. The common enclosure may be designed to be a standard for multiple manufacturers. For example, different power electronic connectors from different manufacturers may be incorporated into the common enclosure such that power electronic devices from different manufacturers are compatible with the common enclosure. The common enclosure may also incorporate safety features. For example, when the panel is opened, the power electronics and controls are shut off. Also, each power electronic section (e.g., each 250 kW section) may be electrically isolated from each other.

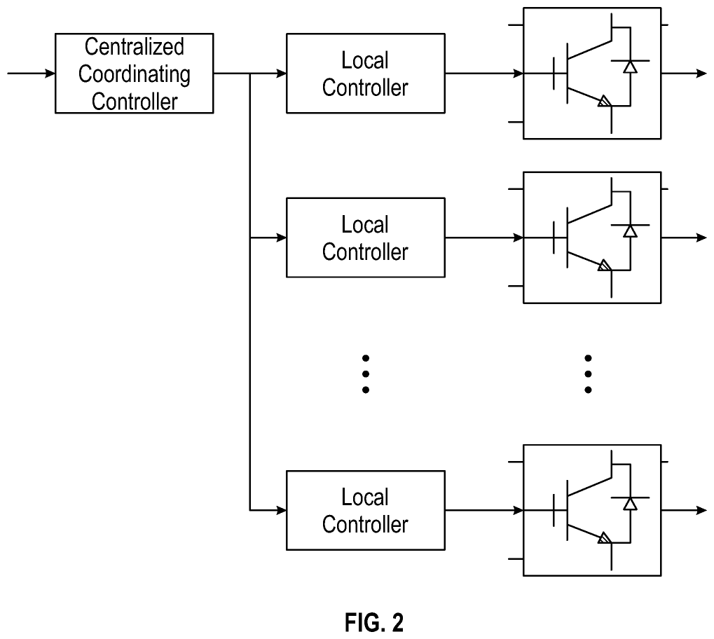

FIG. 2 is a block diagram of a coordinating centralized control architecture. In this architecture, local controllers are coupled to bidirectional inverters, respectively, and a centralized coordinating controller is coupled to the local controllers. The local controllers are responsible for high frequency switching of the power electronic devices of the bidirectional inverters. The local controllers also handle the zero sequencing. The centralized coordinating controller executes an optimization- and data-driven-based control algorithm. The centralized coordinating controller also executes a predictive and model-based control algorithm. The control algorithm is configured to maintain a constant DC voltage despite a varying and uncertain load. The control algorithm is also configured to adjust the current distribution such that the current distribution is evenly distributed and tracks a desired reference current distribution.

The coordinating centralized control features of the disclosure enables a large number of inverters to operate in parallel by using a hierarchical scheme that operates at different time scales with limited communication and forecasting the DC load (e.g., the solar and battery loads). Measurement data is used to learn a model for forecasting the DC load.

The coordinating centralized controller uses an input/output architecture. The input/output architecture incorporates model-based optimization, the goals of which may be expressed as cost functions to minimize. The input/output architecture also measures voltages and currents of the grid and inverters. The outputs of the input/output architecture may be based on a reference voltage or P/Q control for each inverter. The outputs may be based on a polynomial droop curve for each inverter. The outputs are adjusted in real time as a function of the forecasted DC load, e.g., the solar and battery loads.

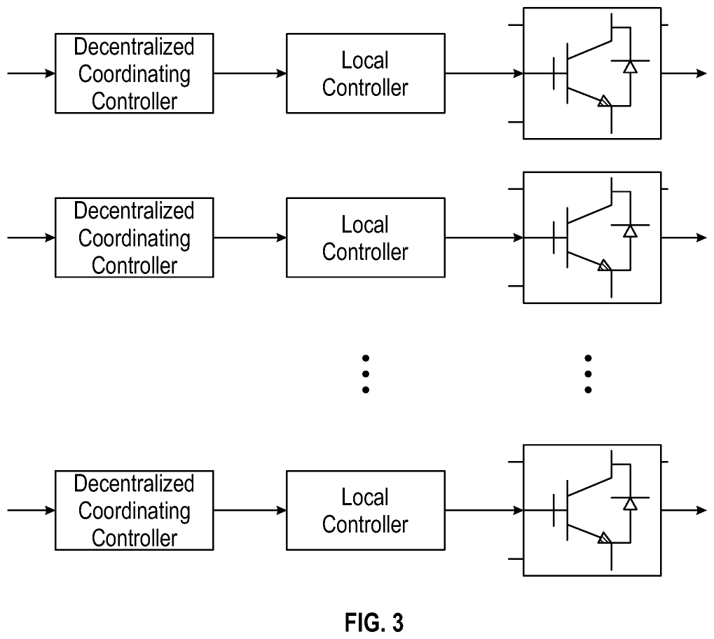

FIG. 3 shows a coordinating decentralized control architecture used in the control system of the disclosure. The coordinating decentralized controller avoids communication and increases modularity of the control system. The coordinating decentralized controller measures voltage and currents of the grid and the local inverters. The coordinating decentralized controllers execute a control algorithms that includes a robust tube prediction algorithm to address the uncertainty of other local inverters not connected to a given local inverter. Also, the control algorithms of the coordinating decentralized controllers may use a polynomial droop curve for each inverter and adjust the outputs of the coordinating decentralized controllers as a function of the forecasted DC load, e.g., the solar and battery loads.

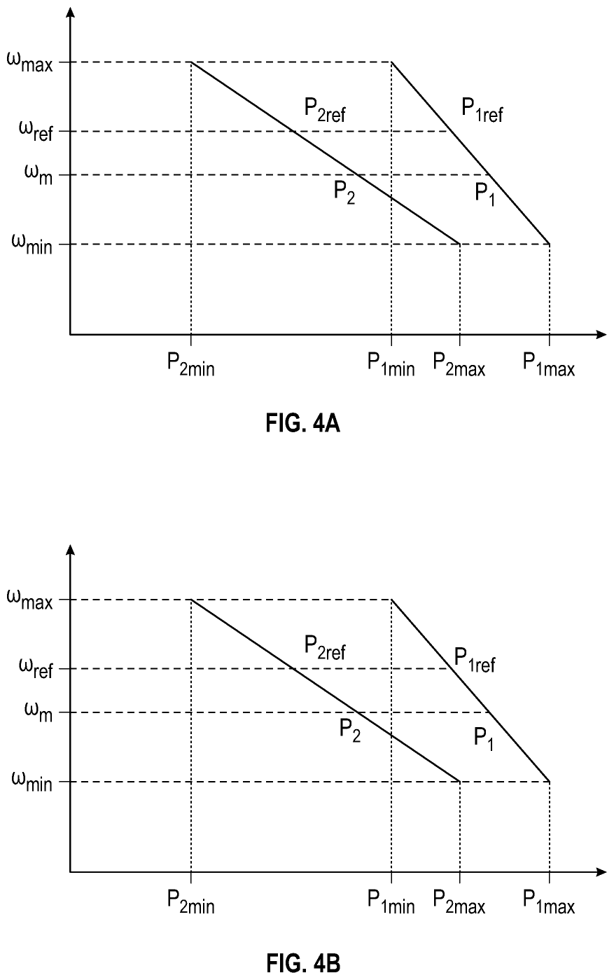

FIGS. 4A and 4B are examples of droop curves used by the control systems of the disclosure. The droop curves may be expressed as ωₘ−ω_{ref}=−g(Pₘ−P_{ref}) and Vₘ−V_{ref}=−h(Qₘ−Q_{ref}), where P_{ref} and Q_{ref} are the set points for active and reactive power, ω_{ref} and V_{ref} are the set points for frequency and inverter voltage magnitude, and g and h are the droop curve slopes. FIG. 4A illustrates the P−ω droop features and FIG. 4B illustrates the Q−V droop features.

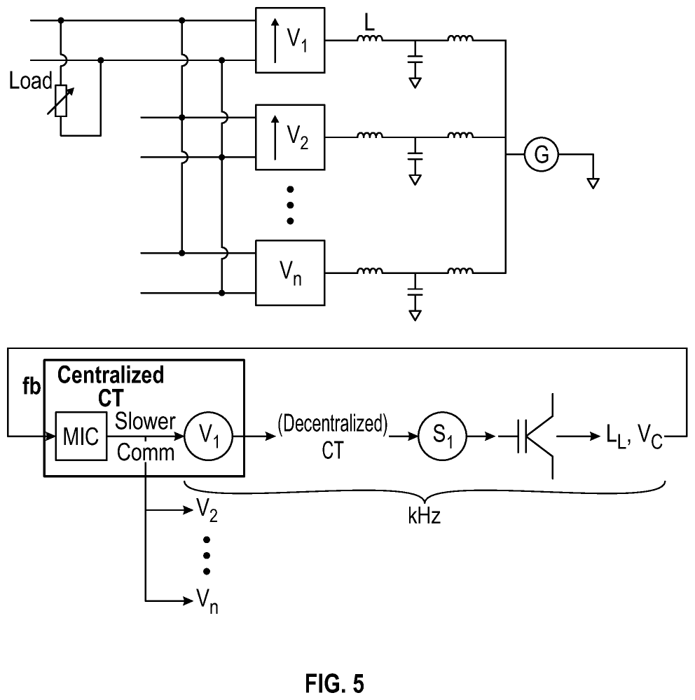

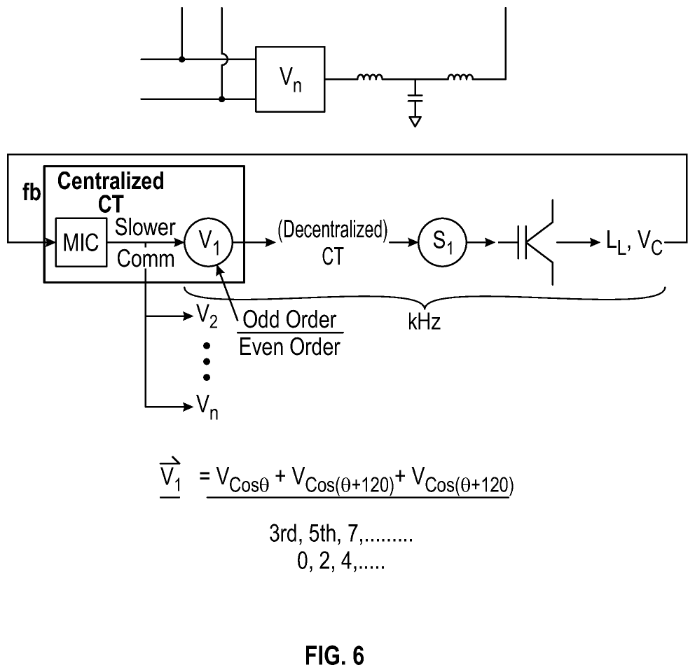

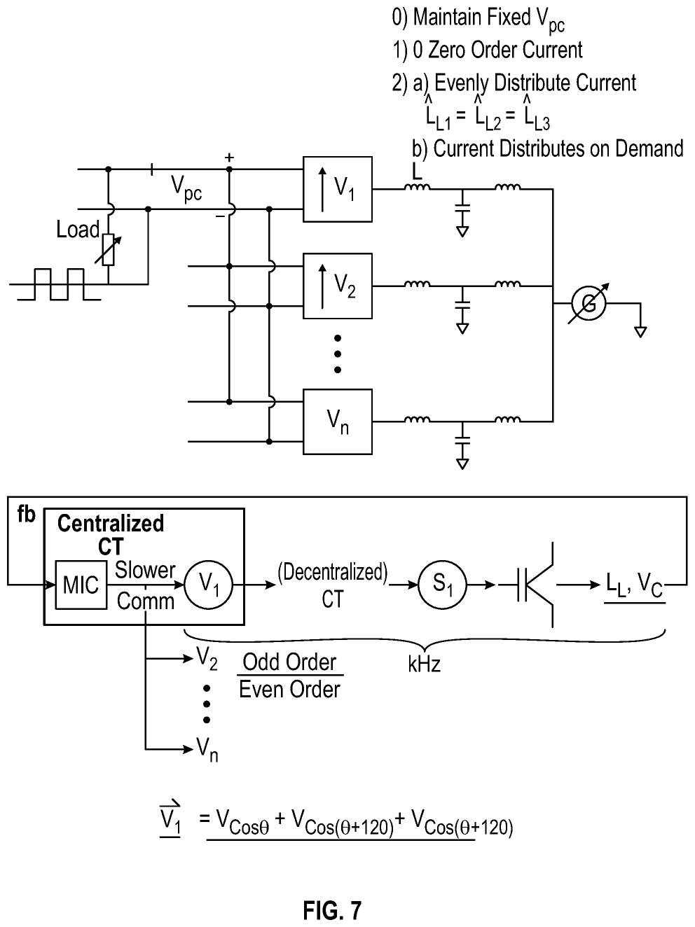

FIGS. 5-7 are circuit diagrams of a system that incorporates centralized and decentralized control features. As shown in FIG. 5A, the power outputs of multiple PV panels supported by multiple solar trackers are electrically coupled to a common bus. A load, such as a motor of a solar tracker, may be electrically coupled in parallel with each of the power outputs. The common bus, in turn, is electrically coupled to multiple inverters, each of which include power switching devices (e.g., power transistors) and LCL filters. The multiple inverters boost the voltage and supply AC power (e.g., three-phase AC power) to the grid.

FIG. 5B shows a block diagram of feedback control system for operating the power switching devices of the inverters of FIG. 5A. The currents through the inductors of the LCL filters and the voltages across the capacitors of the LCL filters are measured and fed to a measurement data input of a microcontroller. The microcontroller executes a software application that implements the functions of the centralized coordinating controller illustrated in FIG. 2. The microcontroller then outputs control command signals to the decentralized controllers. The control command signals may be desired voltage values. The decentralized controllers generate switching signals to drive operation of the power switching devices. The decentralized control may be performed at a speed greater than the centralized coordinating control. For example, the decentralized control may be performed in the kHz range while the centralized control may be performed in the Hz range or greater, e.g., every 10 seconds.

The microcontroller of FIG. 5B executes various control algorithms. The microcontroller executes a space vector modulation (SVM) algorithm, which generates either an odd-order harmonic voltage control signal or an even-order harmonic voltage control signal. The microcontroller generates voltage control signals that causes 0 zero-order current and evenly distributes the current through the inductors of the LCL filters on demand. The microcontroller also controls converters (not shown) to maintain a fixed DC voltage at the inputs to the inverters.

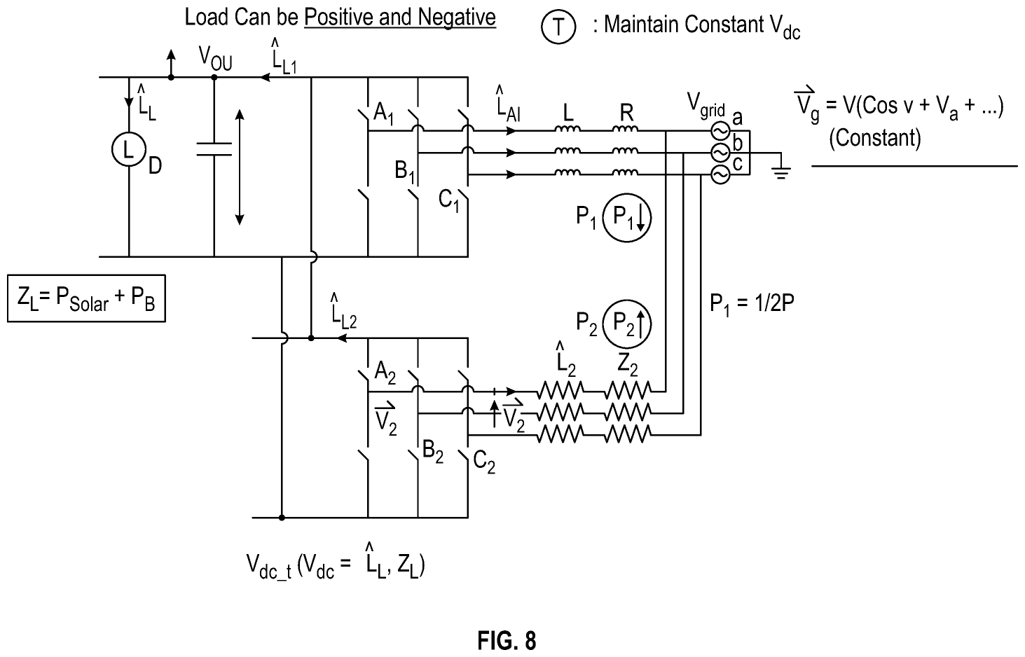

FIG. 8 illustrates a parallel inverter system according to aspects of the disclosure. While FIG. 8 shows a two-inverter configuration, the parallel inverter system may include more than two inverters placed in parallel. Each inverter includes three pairs of series-connected power switching devices, which are connected in parallel with each other. A series RL circuit is coupled to each connection point between each pair of power switching devices. Each inverter includes three outputs coupled to each of the series RL circuits. Each of the three outputs couples to the grid and provides one phase of a three-phase AC output signal to the grid. A load is placed in parallel with each inverter input. The load can be positive and negative. Also, the parallel inverter system is controlled such that a constant DC voltage is applied to the inverter inputs.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

What is claimed is:

1. A common enclosure comprising:
a housing;
inverter input connectors and an inverter output connector coupled to the housing;
a common DC bus mechanically coupled to the housing and electrically coupled to the inverter input connectors;
a common AC bus mechanically coupled to the housing and electrically coupled between the inverter output connector and a power grid connector;
a controller mechanically coupled to the housing and electrically coupled to the common DC bus and the common AC bus;
local controllers coupled to the inverters, respectively;
decentralized controllers coupled to the local controllers, respectively, the decentralized controllers configured to measure voltages and currents of the electrical power grid and the inverters and generated decentralized control signals for the local control controllers based on the measured voltages and currents of the electrical power grid and the inverters; and
a centralized controller in communication with the local controllers and configured to predict a DC load and transmit centralized control signals to the local controllers to maintain a constant voltage on the common DC bus based on the predicted DC load.

2. The common enclosure of claim 1, further comprising a cooling device mechanically coupled to the housing and electrically coupled to the controller.

3. The common enclosure of claim 1, further comprising a communication device mechanically coupled to the housing and electrically coupled to the controller.

4. The common enclosure of claim 1, wherein the communication device includes a Bluetooth communication device.

5. The common enclosure of claim 1, wherein the housing is weather resistant.

6. The common enclosure of claim 1, further comprising mounting hardware coupled to the housing.

7. The common enclosure of claim 1, further comprising an overcurrent and overvoltage protection circuit electrically coupled to the common DC bus and the common AC bus.

8. The common enclosure of claim 1, further comprising:
a panel door rotatably coupled to the housing;
a sensor coupled to the panel door and configured to sense the opening of the panel door; and
a switch coupled to the common DC bus,
wherein the controller is electrically coupled to the sensor and the switch, and is configured to open the switch to disrupt power flow through the common DC bus.

9. The common enclosure of claim 1, wherein the centralized controller executes a polynomial droop control algorithm.

10. The common enclosure of claim 1, wherein each decentralized controller executes a polynomial droop control algorithm.

11. The common enclosure of claim 1, wherein each decentralized controller executes a droop control algorithm.
